(19) United States
(12) Patent Application Publication
(10) Pub. No.: US 2009/0067390 A1
(43) Pub. Date: Mar. 12, 2009

(54) METHOD FOR SPECIFYING TRANSMITTING TIMES FOR CYCLICALLY SENDING OUT DATA MESSAGES, AND SUBSCRIBER DEVICE THEREFOR

(76) Inventors: Frank Grass, Westoverledigen (DE); Keno Reiss, Aurich (DE); Heiko Thole, Heede (DE); Markus Willenborg, Friesoythe-Augustendorf (DE); Lars Reemts, Rhauderfehn (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/854,079

(22) Filed: Sep. 12, 2007

(51) Int. Cl. H04J 3/00

(52) U.S. Cl. 370/336

(57) ABSTRACT

A method for specifying transmitting times for cyclically sending out data messages (3) in a data transmission network (1) is disclosed, which has a plurality of subscriber devices (2) containing transmitting and/or receiving units networked together, comprising allocating a message counter to the individual data messages (3) of a transmitting subscriber device (2) in such a manner that the message counters for a sequence of data messages (3) differ from one another, individually specifying a transmitting time (ST_{x,y+1}) following a transmitting time (ST_{x,y}), for sending out a next data message (3) for each subscriber device transmitting the data message (3), and each subsequent transmitting time of the transmitter, in such a manner that the times between in each case two successive transmitting times (ST_{x,y}, ST_{x,y+1}) of a cycle continuously varies for each transmitting subscriber device (2), and specifying the transmitting times by means of a function for generating a pseudo random number. The pseudo random number is determined in dependence on a subscriber address permanently allocated to the transmitting subscriber device (2) and on the message counter which is allocated to the data message sent out or following.

The invention relates to a method for specifying transmitting times for cyclically sending out data messages in a data transmission network which has a plurality of subscriber devices containing transmitting and/or receiving units which are networked together.

The invention also relates to a subscriber device for transmitting data messages in a data transmission network at cyclically specified transmitting times by means of a transmitting unit.

A transmission of data with data messages in networks is carried in the most varied manner and is applied, for example, in computer networks, mobile telephone networks, field bus applications, house control systems etc. One problem in this arrangement is specifying transmitting times for the individual subscriber devices of a data transmission network in order to avoid data messages being sent out simultaneously by a number of subscriber devices which would lead to a superposition of the data sent out and thus to unusability of the received data for the received subscriber devices.

Time slot methods are known in which each subscriber device is assigned at least one time slot in a transmission cycle in which the transmitting subscriber device is allowed to send out at least one data message. The time slot method requires central assignment of the time slots or correlation of all subscriber devices of a data transmission network with one another. In addition, disturbances by adjacent data transmission networks which are not correlated with the data transmission network considered can barely be controlled in the time slot method, or only with great communication expenditure.

U.S. Pat. No. 4,209,840 A discloses a data transmission protocol with variable-length time slots assigned to the individual subscriber devices. Once a preceding subscriber device has successfully or unsuccessfully transmitted a data message, each subscriber device recalculates its own time slot.

On the basis of this, it is the object of the present invention to create an improved method for specifying transmitting times for cyclically sending out data messages which ensures operation as free of collisions as possible with the least possible correlating expenditure.

The object is achieved by means of the method according to the preamble of claim 1 by specifying the varying transmitting times by means of a pseudo random number which, according to the invention, is determined in dependence on the message counter which is allocated to a data message and on a subscriber address permanently allocated to the transmitting subscriber device.

The transmitting times for the individual subscriber devices are not assigned centrally. Instead, every transmitting subscriber device itself specifies transmitting times in which the transmitting subscriber device sends out a data message. A collision of the transmitting times of a multiplicity of transmitting transcriber devices is prevented to the greatest possible extent by the fact that the transmitting times are in each case respecified individually with the aid of the pseudo random number based on the subscriber address and the message counter, after the sending-out of a data message, in such a manner that the periods between in each case two successive transmitting times vary continuously. The transmitting times of a multiplicity of subscriber devices are scrambled in this manner in such a way that the probability of two or more subscriber devices sending out data messages simultaneously at one time is very low.

The entire data transmission network is thus operated in the manner of a pseudo random selection distribution of the transmitting times assigned to the individual subscriber devices.

The method also has the advantage that due to the assigned time slots, the subscriber devices only need to be active for a brief period and thus a long battery life can be achieved.

Use is made of the fact that each subscriber device is assigned a subscriber address allocated individually and permanently, which is used for specifying the respective transmitting times. The subscriber address is a constant influencing variable of a pseudo random function which calculates the respective transmitting time in a continuously varying manner.

Use is also made of the fact that a message counter is in each case allocated to the individual data messages in such a manner that the message counters of a sequence of data messages differ from one another. The message counters can be incremented, for example, so that the message counter of a preceding data message is less by one than the message counter of the subsequent data message. This message counter, in conjunction with the subscriber address, is an influencing variable for the algorithm or the pseudo random function which calculates the respective transmitting time for the transmitting subscriber device.

In particular, the transmitting times are specified with a function for generating a pseudo random number. In this arrangement, it is advantageous if a minimum cycle time specified for a transmitting cycle is added to the pseudo random number. This ensures that the nest transmitting time is not located within the transmitting period of the preceding transmitting time.

It is often also required to repeat the sending-out of a data message, for example in the case where the transmission channel was disturbed. In this case, it is advantageous to specify a transmitting time for a repeated sending-out of a data message also in dependence on a pseudo random number. This pseudo random number can be calculated again in dependence on the message counter and on the subscriber address.

A transmitting time for a subsequent data message is preferably specified at the time at which a preceding data message is sent out. The transmitting time specified is then the period between the beginnings of the transmitting cycles of two successive data messages, that is to say the period between the transmitting times at which the data transmissions start.

The transmitting subscriber device preferably switches to a receiving mode for receiving data messages immediately after the transmitting subscriber device has sent out a data message. This ensures that a return message of a subscriber device receiving the data message is detected by the transmitting subscriber device. This receiving period should then be considered when specifying the subsequent transmitting time.

It is also advantageous if the subscriber device for receiving a data packet also determines the next transmitting time for the transmitting subscriber device for sending out a subsequent data message in dependence on a subscriber address permanently allocated to the transmitting subscriber device and on a message counter individually allocated to the data packet. In this arrangement, the subscriber address and the message counter are usually a component of the transmitted data packet and can be utilized by the receiving subscriber device for calculating the next transmitting time. The only prerequisite is that the algorithm or the formula for specifying the subsequent transmitting time is generally known. For this purpose, a pseudo random number generator can be utilized, for example.

It is also the object of the present invention to create an improved subscriber device for transmitting data messages in a data transmission network.

The object is achieved by means of the subscriber device having the features of claim 8.

Advantageous embodiments are described in the subclaims.

In the text which follows, the invention is explained in greater detail with reference to the attached drawings, in which:

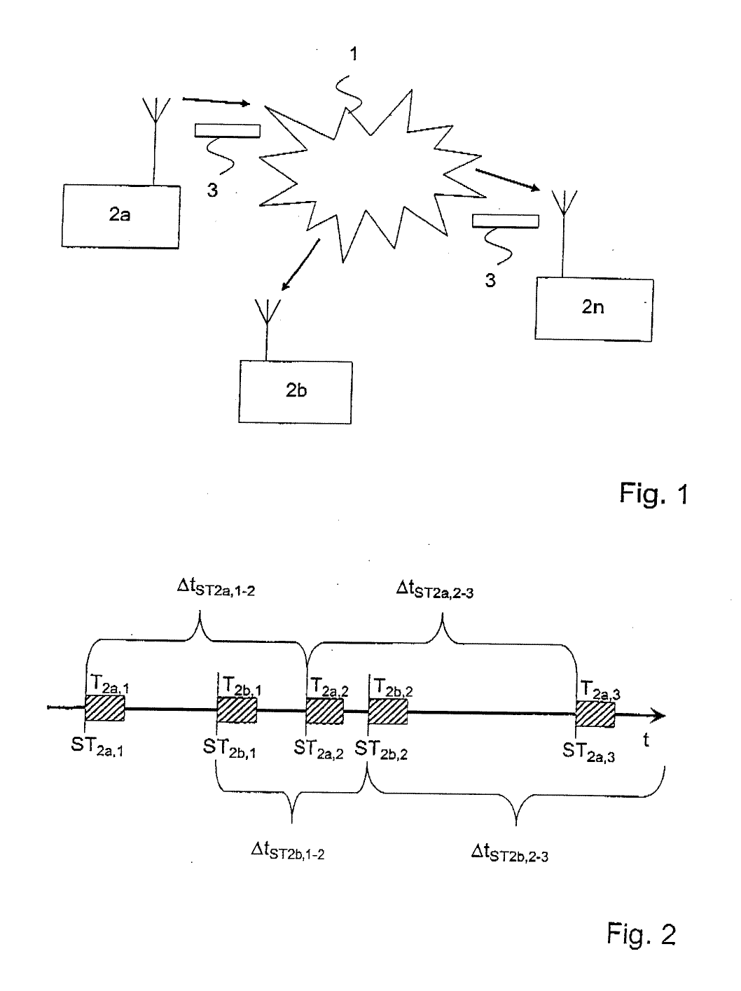

FIG. 1 shows a sketch of a data transmission network with subscriber units;

FIG. 2 shows a time line with transmitting times continuously varying for each subscriber unit.

The figure shows a sketch of a data transmission network 1 with a multiplicity of subscriber devices 2a, 2b, . . . , 2n which exchange data messages 3 with one another by radio via the data transmission network 1. The data messages contain user data in the usual manner, which are transmitted in a data packet together with header information, control data and check data. The data message contains a subscriber address of the transmitting subscriber device 2 and a message counter. The message counter is specified individually for each data packet 3 sent out by each transmitting subscriber device 2 and thus varies from data packet 3 to data packet 3. The message counter of data packet 3 is preferably incremented to the next data packet 3 so that the message counter only repeats after a cycle depending on the bit length of the message counter.

To then avoid a collision of the transmitting times for the data packets 3 which are transmitted by subscriber devices 2 by radio via the transmission network 1, the transmitting times ST_{x,y} with the subscriber device 2x and the number y of the data message 3 are respecified for each sending-out of a data message 3 in a transmission cycle. There is no correlation of the transmitting times ST_{x,y} between the individual subscriber devices 2 or any central issuing of these transmitting times ST_{x,y}, for example with the aid of time slots. Instead, the transmitting times ST_{x,y} are specified virtually randomly by the subscriber devices 2 so that the time intervals between two successive transmissions of data messages 3 vary continuously. This leads to the probability of two or more transmitting subscriber devices 2 selecting the same transmitting time (ST_{x,y}) for sending out a data message 3 being considerably reduced without having to specify fixed conditions.

FIG. 2 shows a timing diagram with a number of transmitting times ST_{x,y} at which the sending-out of a data message 3 begins in a transmitting cycle.

At a first transmitting time ST_{2a,1}, the first subscriber device 2a transmits the first data message 3 of a transmitting cycle of the subscriber device 2a. At this time, the first subscriber device 2a already calculates the next transmitting time ST_{2a,2} at which the next data message 3 is sent out. This is preferably done by means of a function for calculating a pseudo random number which is determined in dependence on the subscriber address of the first subscriber device 2a and on the message counter of the data message 3 sent out or following. The pseudo random number can also be calculated with the aid of a multiplier and of an offset value for the function for determining the pseudo random number in such a manner that a particularly uniform random distribution of the transmitting times ST_{x,y} with respect to time t is obtained.

Since the function for calculating the pseudo random number supplies a result which, although it is statistically randomly distributed, is predictable, the subscriber devices 2 receiving the data message 3 can calculate with the aid of the message counter contained in the received data message 3 and of the message address of the transmitting subscriber device 2a when the transmitting subscriber device 2a is sending out the next data packet 3.

In the same manner, the further subscriber devices 2b, . . . , 2n specify the transmitting times for sending out their data packets 3 so that the transmissions t_{x,y} of the data packets vary, or are virtually scrambled, over a period t.

To avoid the subsequent transmitting time ST_{x,y+1} falling into a transmitting cycle for a data packet 3, a minimum cycle time specified for a transmitting cycle is added to the pseudo random number generated by a random number generator.

Subscriber devices such as meteorological sensor, energy sensor, heating control etc. can thus send their data cyclically with a particular cycle time. In this arrangement, the time varies for each transmitting cycle for a data message 3. The total number of possible cycle times depends on the temporal resolution required for transmitting a data message 3 and possibly for receiving a return message in the bidirectional transmission and the repetition of data messages 3.

For example, a bidirectional transmission of data messages 3 can be provided in which the reception of a data message 3 is confirmed by the subscriber device 2 addressed. The transmission of a data message 3 which has not been confirmed can be repeated once, twice or several times. The time at which the repetitions are transmitted is then also specified relative to the transmitting time of the original transmission of the data packet 3 with the aid of a pseudo random number. In the case where a subscriber device 2 which cyclically transmits data messages 3 is to be informed about something such as, for example, configuration data, this subscriber device 2 can be addressed directly after the subscriber device 2 has sent out its cyclic data packet 3. For this purpose, the cyclically transmitting subscriber device 2 must switch to reception for a defined period of time within a specified time after sending out a data packet 3.

1. Method for specifying transmitting times for cyclically sending out data messages (3) in a data transmission network (1) which has a plurality of subscriber devices (2) containing transmitting and/or receiving units networked together, comprising allocating a message counter to the individual data messages (3) of a transmitting subscriber device (2) in such a manner that the message counters of a sequence of data messages (3) differ from one another, individually specifying a transmitting time (ST_{x,y+1}) following a transmitting time (ST_{x,y}), for sending out a next data message (3) for each subscriber device transmitting the data message (3), and each subsequent transmitting time of the transmitter, in such a manner that the times between in each case two successive transmitting times (ST_{x,y}, ST_{x,y+1}) of a cycle continuously varies for each transmitting subscriber device (2), and specifying the transmitting times by means of a function for generating a pseudo random number, characterized in that the pseudo random number is determined in dependence on a subscriber address permanently allocated to the transmitting subscriber device (2) and on the message counter which is allocated to the data message sent out or following.

2. Method according to claim 1, characterized by incrementing a message counter allocated to a preceding data message (3) of a transmitting subscriber device (2) and allocating the incremented message counter to the subsequent data message (3) of the transmitting subscriber device (2).

3. Method according to claim 1, characterized by adding a minimum cycle time, specified for a transmitting cycle, to the pseudo random number.

4. Method according to claim 1, characterized by specifying a transmitting time for a repeated sending-out of a data message (3) in dependence on a pseudo random number.

5. Method according to claim 1, characterized in that a transmitting time for a subsequent data message (3) is specified on sending out a data message (3) and the transmitting time is a period between the beginnings of the transmitting cycles of two successive data messages (3) of a transmitting subscriber device.

6. Method according to claim 1, characterized in that the transmitting subscriber device (2) switches to a receiving mode for receiving data messages (3) after the transmitting subscriber device (2) has sent out a data message (3).

7. Method according to claim 1, characterized in that the subscriber device (2) receiving a data message (3) determines the next transmitting time for the transmitting subscriber device (2) for sending out a subsequent data message (3) in dependence on a subscriber address permanently allocated to the transmitting subscriber device (2) and on a message counter allocated individually to the data message (3).

8. Subscriber device (2) for transmitting data messages (3) in a data transmission network (1) at cyclically specified transmitting times by means of a transmitting unit and by means of a transmitting time control unit which is set up for allocating a message counter to the individual data messages (3) of a transmitting subscriber device (2) in such a manner that the message counters of a sequence of data messages (3) differ from one another, and for individually specifying a transmitting time (ST_{x,y+1}), following a transmitting time (ST_{x,y}) for a data message (3), for sending out a next data message (3) for transmitting subscriber device (2) in such a manner that the times between in each case two successive transmitting times (ST_{x,y}, ST_{x,y+1}) of a cycle continuously varies for the subscriber device (2), characterized in that the transmitting time control unit has a random number generator and is set up for specifying the transmitting times in functional relationship with a pseudo random number generated by the random number generator in dependence on an individual subscriber address permanently allocated to the subscriber device (2) and on the message counter allocated to the data message (3) sent out or following.

9. Subscriber device (2) according to claim 8, characterized in that the transmitting time control unit is set up for incrementing a message counter allocated to a preceding data message (3) of a transmitting subscriber device and allocating the incremented message counter to the subsequent data message (3) of the transmitting subscriber device (2).

10. Subscriber device (2) according to claim 8, characterized in that the transmitting time control unit is set up for adding a minimum cycle time, specified for a transmitting cycle, to the pseudo random number.

11. Subscriber device (2) according to claim 8, characterized in that the transmitting time control unit is set up for specifying a transmitting time for a repeated sending-out of a data message (3) in dependence on the pseudo random number.

12. Subscriber device (2) according to claim 8, characterized in that the subscriber device (2) has a receiver and is set up for switching to a receiving mode for receiving data messages (3) immediately after the subscriber device (2) has sent out a data message (3).

13. Subscriber device (2) according to claim 8, characterized in that the transmitting unit is a radio transmitting unit.
